(19) United States
(12) Patent Application Publication
(10) Pub. No.: US 2012/0048399 A1
(43) Pub. Date: Mar. 1, 2012

(54) EXPLOSION PROTECTION VALVE FOR INTERRUPTING A FLUID FLOW IN A PIPELINE

(75) Inventors: Jürg Zellweger, Waldstadt (CH); Giuseppe Walter Aloi, Widnau (CH)

(73) Assignee: RICO-SICHERHEITSTECHNIK AG, Herisau (CH)

(21) Appl. No.: 13/319,365

(22) PCT Filed: May 11, 2010
(86) PCT No.: PCT/EP2010/056435

§ 371 Date: Nov. 10, 2011

(30) Foreign Application Priority Data
May 14, 2009 (CH) 00757/09

(51) Int. Cl. F16K 17/04

(52) U.S. Cl. 137/527

(57) ABSTRACT

Provided is a closing body mounted in a valve housing (4), the closing body being designed as a valve plate (9) and maintained in an operating position by a spring load action and/or by the effect of the fluid flow in the valve housing. The valve plate is hinged in the valve housing.

The invention relates to an explosion protection valve for interruption of a fluid flow in a pipeline according to the preamble of claim 1.

Valves of this type have long been known and customary for installation in plants having liquid or gaseous fluid flows. The main purpose is to interrupt the propagation of pressure and/or fire waves in order to prevent further damage to usually sensitive plant parts. The explosion protection valves may in this case have different closing bodies which are designed as hollow bodies, flaps or slides. One disadvantage of known explosion protection valves is that the construction for triggering the closing action is usually complex. Particularly for use in pneumatic conveying lines, there has not hitherto been known any valves which have a simple type of construction.

An object of the invention, therefore, is to provide an explosion protection valve of the type initially mentioned, which can be produced simply and cost-effectively and which is suitable especially for use in pneumatic aspiration lines with a dust concentration. In the event of an explosion, the valve is to be capable of decoupling the line reliably and of being brought into the operating position again quickly. In the closing position, the closing body should withstand even high loads. This object is achieved, according to the invention, by means of an explosion protection valve which has the features in claim 1.

The closing body is in this case a flap plate which can be held in the operating position under spring prestress and/or under the action of the fluid flow in the valve housing. By a flap plate being used, which can be held in the operating position under spring prestress, the explosion protection valve is operable in any installation position.

The flap plate can be produced relatively simply from sheet steel and, if it has appropriate curvature, can be exposed to even high pressure loads. Spring prestress which may possibly be only very small may suffice to maintain the open position, depending on the nature of the flap plate. However, even the fluid stream itself may be sufficient for keeping it open. A hollow body can be produced especially simply from two curved surface segments.

The flap plate is articulated in the valve housing and between the operating position and the closing position executes a pivoting movement of less than 90°, preferably of less than 60°. Articulation in the valve housing has the advantage, as compared with a slide, that there is no need for any sliding linear seals. A low pivoting movement of less than 90° ensures a rapid closing action.

The flap plate can be held in the operating position under spring prestress transverse to a longitudinal direction of the flow. In this case, the valve housing can have a protuberance for the fluid flow in the plane of the flap plate being held in the operating position. The flap plate thus projects into the fluid flow which has to bypass the flap plate via the protuberance. If the protuberance is configured appropriately, the flap plate can be bypassed by the flow not only on one side, but on a plurality of sides. If a planar flap plate or a planar hollow body is used, it is especially advantageous if the valve housing has two valve seats, the flap plate being capable of being moved out of the operating position into a closing position in two directions of movement and of being held there. The valve thus closes when a pressure wave impinges onto the flap plate in the flow direction or opposite to the flow direction.

A further advantageous refinement is achieved if the valve housing is designed as a pipe of circular cross section and if the flap plate is curved codirectionally to the pipe curvature, said flap plate bearing against a stop in the valve housing in the operating position under the action of the fluid flow. It is especially cost-effective to design the valve housing as a simple pipe because commercially available standard pipes can be used. The curvature of the flap plate makes relatively extensive opening possible, the stop preventing the flap plate coming to bear completely against the pipe inner surface area. Sufficient counterpressure surface therefore remains for the purpose of closing the flap plate. In this design, the valve seat may be formed by the end face of an inner ring arranged in the valve housing. It is also conceivable, however, that the valve seat is formed directly by the valve housing.

The flap plate may basically be formed as a single-layer or multilayer surface segment or as a hollow body.

The invention also relates to the specific use of one of the above-described explosion protection valves in the aspiration line of a dust extraction plant between a dust filter and a dust source. In this case, the filter is to be decoupled from the preceding plant components. This avoids the situation where, for example, a dust explosion in the filter may propagate as far as the extraction point on a machine.

Further advantages and refinements of the invention may be gathered from the exemplary embodiments described below and from the drawings in which is shown:

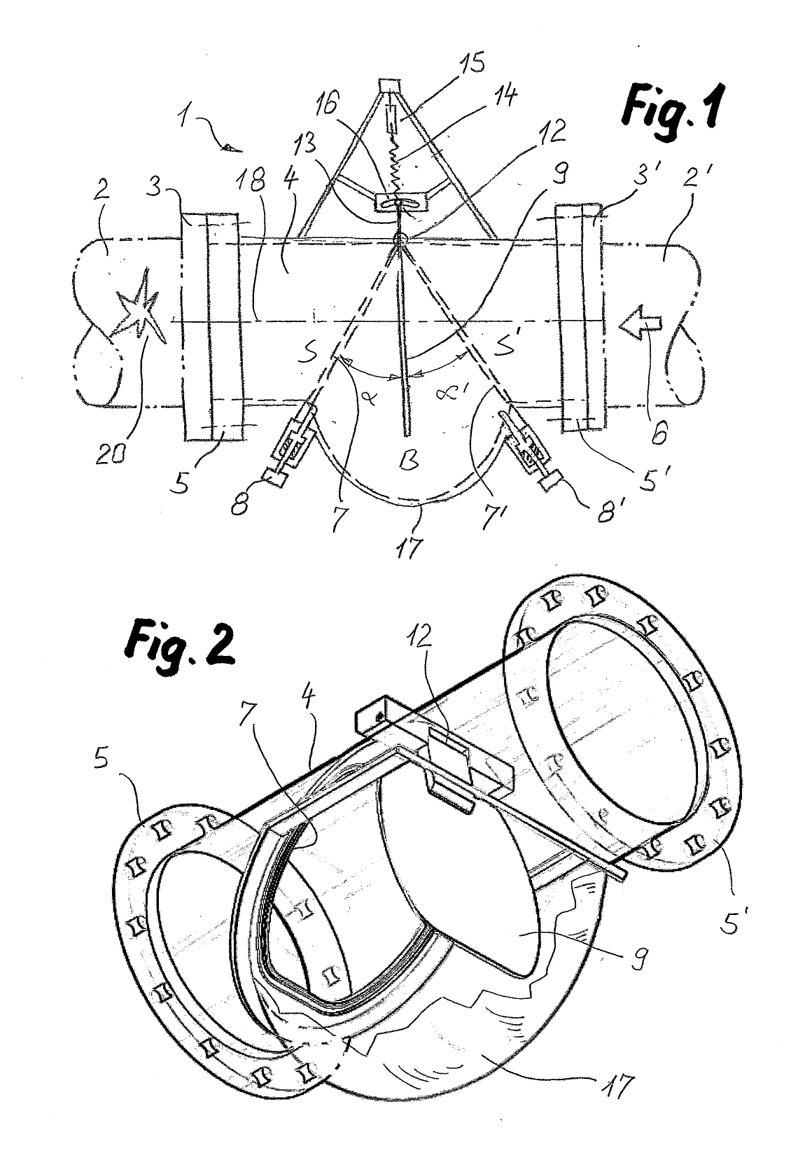

FIG. 1: a greatly simplified side view of a first embodiment of an explosion protection valve with a planar flap plate,

FIG. 2: a partially cut away perspective illustration of the valve according to FIG. 1 obliquely from below,

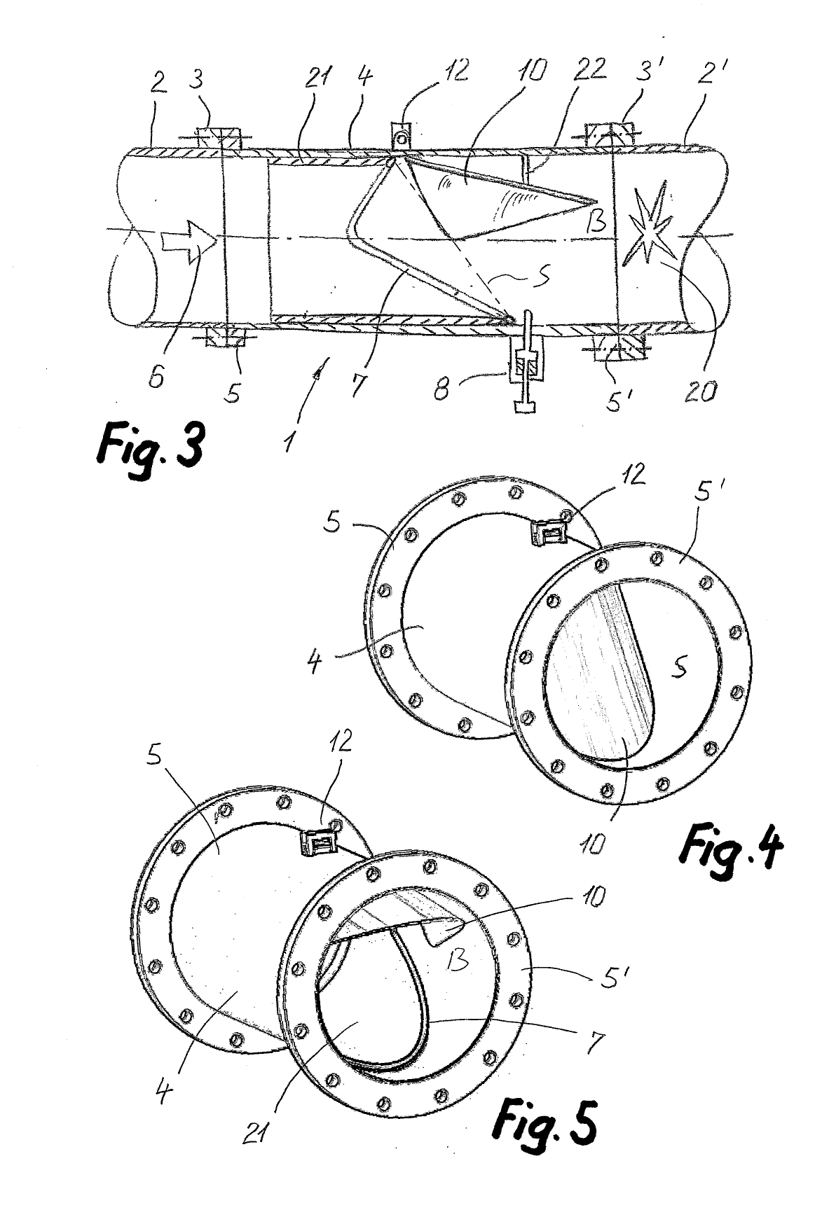

FIG. 3: a cross section through a second embodiment of an explosion protection valve with a curved flap plate,

FIG. 4: a perspective illustration of the valve according to FIG. 3 with a closed flap plate,

FIG. 5 the valve according to FIG. 4 with an open flap plate,

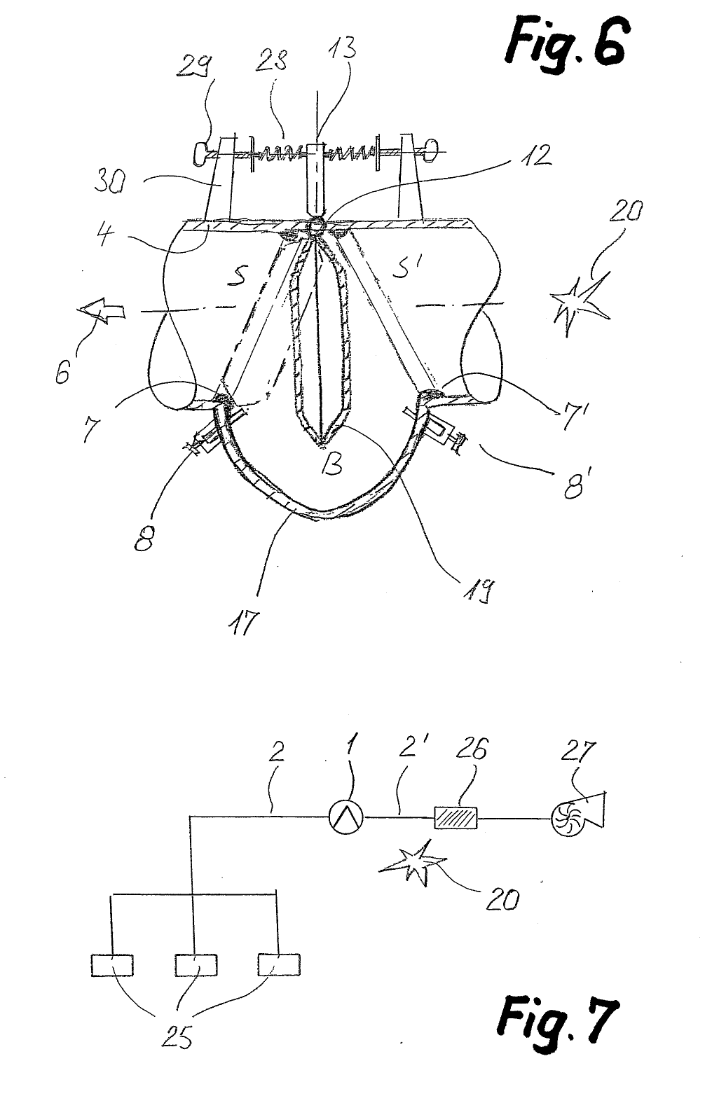

FIG. 6 a cross section through a further exemplary embodiment with a closing body designed as a hollow body,

FIG. 7 a diagrammatic illustration of a dust extraction plant,

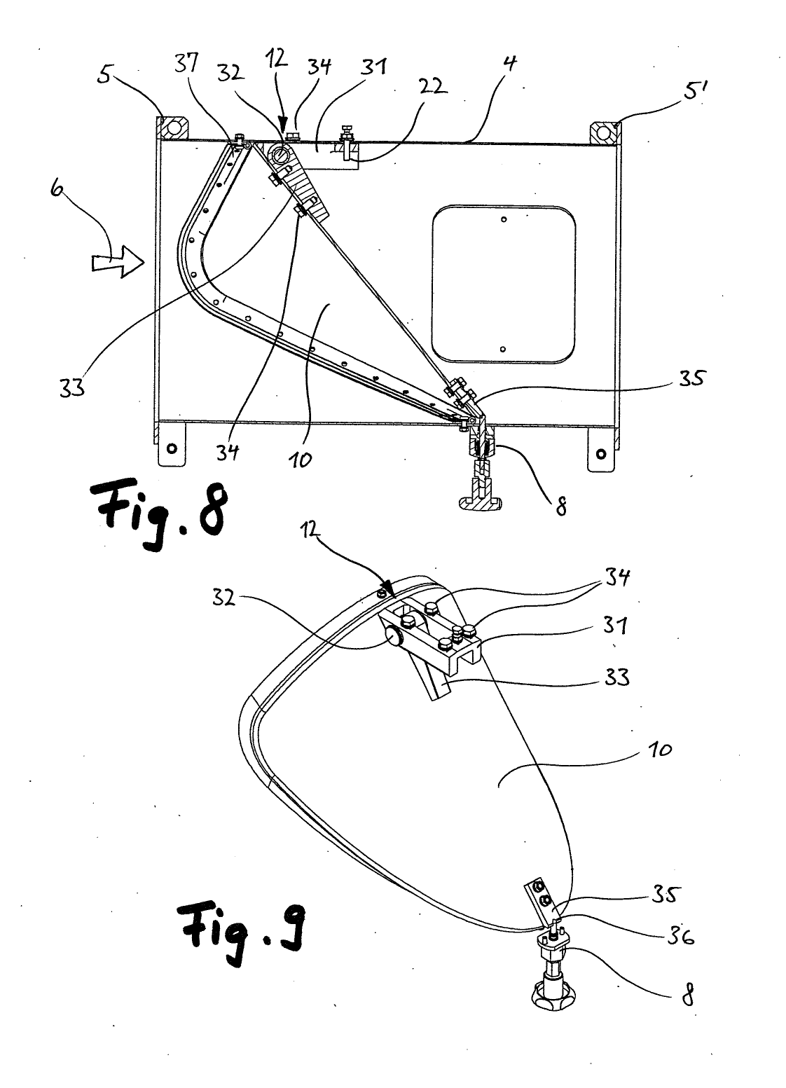

FIG. 8 a cross section through a further exemplary embodiment of an explosion protection valve with a curved flap plate in the closing position, and

FIG. 9 a perspective view of a flap plate according to FIG. 8.

As illustrated in FIG. 1, the explosion protection valve designated in general by 1, is composed of a valve housing 4 with a longitudinal mid-axis 18. The valve housing is closed off at both ends by means of a flange 5, 5′, one at each end. The valve can thus be coupled between the pipelines 2, 2′ to a pipe-side flange 3, 3′ on either side. The planar flap plate 9 is articulated at a flap joint 12 in the valve housing. On the outside of the valve housing 4, a lever arm 13 forms the continuation of the flap plate 9. Fastened to this lever arm is a tension spring 14, the tensioning force of which can be set by means of a setting device 15. Additionally, spring pressure pieces 16 on both sides of the lever arm 13 can stabilize the position of the flap plate 9. Under the action of the tension spring 14, the flap plate is held in the operating position B in the fluid flow approximately at right angles to the longitudinal mid-axis 18.

A protuberance 17 is arranged on the valve housing 4 in the plane of the operating position B, so that the flow can bypass the flap plate on the underside and laterally. As is evident particularly from FIG. 2, the flap plate 9 is beveled in the outermost pivoting region in order to improve the flow action. A valve seat 7, 7′ is arranged on each of the two sides of the flap plate 9 at an angle α, α′ of approximately 30° to the operating position B. Moreover, in the region of each of the two valve seats, a locking device 8, 8′ is arranged, which has the task of holding the flap plate 9, pressed against the valve seat, in each case in the closing position S, S′.

If, for example, an explosion 20 occurs in the pipe 2, the flap plate 9 moves against the valve seat 7′ and is held there in the closing position S′. The advantage of this version, however, is that it is double-acting, so that, even in the case of excessive pressure in the pipe 2′, a closing movement against the valve seat 7 is triggered. Since the flap plate is held open with the aid of spring prestress, the valve can be installed in any position.

If the valve is installed horizontally, it is especially advantageous if the flap joint 12 comes to lie at the top. The flap plate 9 is in this case also held in the operating position B by the force of gravity, and the dust is not caught in the flap joint 12, but instead falls into the protuberance 17.

A further type of construction is evident from FIGS. 3 to 5. Here, the valve housing 4 is composed of a pipe of circular cross section which is likewise provided at both ends with connecting flanges 5, 5′. A curved flap plate 10 is likewise mounted pivotably at a flap joint 12, but the spring device for keeping it open in the operating position is omitted. In the operating position B, the curved flap plate 10 bears against the stop 22 under the action of the fluid flow 6.

As is evident particularly from FIG. 5, the flap plate 10 is curved codirectionally to the pipe curvature. The valve seat 7 is formed by the end face of an inner ring 21, the contour of the valve seat 7, of course, being adapted to the outer margin of the flap plate. It is also conceivable to have a variant in which, if the flap plate is configured optimally, the inner ring 21 and valve seat 7 may be dispensed with. In this case, the valve housing 4 directly forms with the flap plate 10 the leaktight closure with the leaktightness necessary for preventing the propagation of an explosion. The stop 22 ensures that, in the event of an explosion 20 in the pipe 2′ sufficient engagement surface remains on the flap plate in order to move the latter into the closing position S according to FIG. 4. As a result of the curvature toward the explosion side, the flap plate has good pressure resistance. In the event of an explosion, the flap plate is likewise held in the closing position S via the locking device 8. When the fluid flow 6 ceases, the flap plate also sinks down, but it cannot overcome the locking device 8, instead resting only loosely on the latter.

In specific instances, it will also be conceivable in this embodiment to integrate the seal on the end face into the flap plate 10 or to dispense entirely with this seal. The inner ring 21 could then be omitted because the flap plate seals directly on the inside of the tubular valve housing.

This version clearly acts only in the case of an explosion or a suction wave in one direction. Moreover, without additional aids, the valve can be installed only in a horizontal position. However, additional coupling of a spring device for holding up the flap plate could be envisaged. The valve could thus be used in any desired installation position.

FIG. 6 shows, greatly simplified, a cross section through a further exemplary embodiment of an explosion protection valve, in which the connecting flanges and connecting pipelines are no longer shown. However, the basic principle is similar to that of the exemplary embodiment according to FIG. 1. The closing body is not designed as a planar surface segment, however, but as a hollow body 19 which is composed of two slightly curved individual segments. In this case, however, an essentially sheet-like plate with parallel side walls is likewise formed. A closing body of this type is clearly especially bend-resistant.

The hollow body is likewise articulated on the valve housing 4 via a joint 12 and is provided with a lever arm 13. The operating position B is held by means of two helical compression springs 28 which are supported on an abutment 30. The spring force can be influenced with the aid of set screws 29.

The valve housing likewise has two valve seats 7 and 7′ with corresponding seals for sealing off in the closing position S. Designing the closing body as a hollow body makes it possible to accommodate the seals especially advantageously, so that these can be bypassed by the flow, without accumulations of dirt being capable of building up.

In FIG. 6, the hollow body 19 is illustrated in the closing position S after an explosion 20 by dashed and dotted lines. In this position, the hollow body is held by the locking device 8. The hollow body can clearly also be held in the same way in the second closing position S′.

FIG. 7 illustrates diagrammatically a dust extraction plant in which three different machines 25 have dust extracted via a pipeline 2, 2′. The suction action is in this case generated by a fan 27, upstream of which a filter 26 is connected. The explosion protection valve 1 is installed between the machines 25 and the filter 26 so that, in the event of an explosion 20 in the pipeline 2′ the machines 25 and their operators are protected.

A further exemplary embodiment of an explosion protection valve is similar to the embodiment according to FIGS. 3 to 5 is illustrated in FIGS. 8 and 9. The valve housing 4 is again composed of a pipe of circular cross section. The valve housing 4 is provided on both sides with a connecting flange 5, 5′. The flap plate 10 is curved so that, in the operating position B (see FIG. 3), its curvature approximately follows the curvature of the inner wall of the valve housing 4. The flap plate 10 is mounted pivotably at a flap joint 12 and is moved into the operating position B (cf. FIG. 3) solely by the action of the fluid flow 6. The flap joint 12 is arranged inside the valve housing 4 and is composed essentially of a U-shaped profile element 31 and of a nose part 33 fastened pivotably thereto via an axial pin 32. The U-shaped profile element 31 is fastened to the valve housing 4 and the nose part 33 is fastened to the flap plate 10 by means of screws 34. It will be appreciated that other fastening variants, such as, for example, welding, adhesive bonding, riveting etc., will be used instead of screw connections. In order to prevent the flap plate 10 from coming to bear completely on the valve housing 4 in the operating position, and thereby to afford sufficient engagement surface in the event of an explosion, a stop 22 in the form of a threaded bolt is arranged on the U-shaped profile element 31. This threaded bolt penetrates from outside through the valve housing 4 and the profile element 31 and prevents the nose part 33 from swinging flush into the profile element 31, thus preventing the flap plate 10 from coming to bear completely on the valve housing 4. Since the threaded bolt penetrates through the valve housing 4 outwardly, it becomes possible that the stop 22 can be adjusted from outside according to the required use. As already described with regard to FIG. 3, when the fluid flow 6 ceases, the flap plate 10 sinks down in relation to the closing position, but because of its low dead weight cannot overcome the locking device 8, instead lying only loosely on the latter. Only in the event of an explosion and the corresponding explosion pressure is the flap plate 10 pressed so firmly into the closing position S (cf. FIG. 3) that the resistance of the locking element 8 is overcome and the flap plate 10 is thus secured in a closing position. So that the locking mechanism can be adjusted and in order to protect the flap plate 10 from excessive wear, a reinforcing element 35 is arranged on that side of the flap plate which lies opposite the flap joint 12, where the flap plate 10 comes into contact with the locking element 8. This reinforcing element 35 is fastened to the flap plate 10 by means of a screw connection. Alternatively, the reinforcing element 35 may be adhesively bonded, welded or riveted or fastened by other means to the flap plate 10. The reinforcing element 35 has at its front end a recess 36 which matches with the locking element 8 when the flap plate is in the closing position. Alternatively to the seal with an inner ring 21 according to FIG. 3, the seal is fixed to the valve housing 4 only by means of a strip 37.

1.-8. (canceled)

9. An explosion protection valve (1) for interrupting a fluid flow (6) in a pipeline (2, 2′), with a closing body which is mounted in a valve housing (4) and which can be moved, under the action of a closing pressure deviating from an operating pressure, out of an operating position (B) into a closing position (S) in which the closing body bears against a valve seat (7, 7′) and can be held in the closing position by means of a locking device (8, 8′), characterized in that the closing body is a flap plate (9, 10, 19) which can be held in the operating position (B) under spring prestress and/or under the action of the fluid flow in the valve housing (4), the flap plate being articulated in the valve housing (4) and, between the operating position (B) and the closing position (S), executing a pivoting movement of less than 90°, preferably of less than 60°.

10. The explosion protection valve as claimed in claim 9, characterized in that the flap plate (9, 19) is held in the operating position (B) under spring prestress transverse to a longitudinal direction of the flow, the valve housing (4) having a protuberance (17) for the fluid flow (6) in the plane of the flap plate which is held in the operating position.

11. The explosion protection valve as claimed in claim 10, characterized in that the valve housing (4) has two valve seats (7, 7′), the flap plate being capable of being moved out of the operating position (B) into a closing position in two directions of movement and of being held there.

12. The explosion protection valve as claimed in claim 9, characterized in that the valve housing (4) is designed as pipe of circular cross section, and in that the flap plate (10) is curved codirectionally to the pipe curvature and, in the operating position (B), bears against a stop (22) in the valve housing under the action of the fluid flow.

13. The explosion protection valve as claimed in claim 12, characterized in that the valve seat (7) is formed by the end face of an inner ring (21) arranged in the valve housing (4).

14. The explosion protection valve as claimed in claim 12, characterized in that the valve seat (7) is formed directly by the valve housing (4).

15. The explosion protection valve as claimed in claim 9, characterized in that the flap plate (9, 10, 19) is formed as a surface segment or as a hollow body.
